(19) United States
(12) Patent Application Publication
(10) Pub. No.: US 2025/0138546 A1
(43) Pub. Date: May 1, 2025

(54) SENSOR MEASUREMENT GRID COMPLEXITY MANAGEMENT

(71) Applicant: QUALCOMM Incorporated, San Diego, CA (US)

(72) Inventors: Vishnuu APPAYA DHANABALAN, Munich (DE); Volodimir SLOBODYANYUK, San Diego, CA (US); Radhika Dilip GOWAIKAR, San Diego, CA (US); Makesh Pravin JOHN WILSON, San Diego, CA (US); Avdhut JOSHI, San Marcos, CA (US); James POPLAWSKI, Canton, MI (US)

(21) Appl. No.: 18/819,026

(22) Filed: Aug. 29, 2024

Related U.S. Application Data
(60) Provisional application No. 63/594,579, filed on Oct. 31, 2023.

(51) Int. Cl. G05D 1/246; G05D 109/10; G05D 111/10; G05D 111/30; G05D 111/67

(52) U.S. Cl. CPC G05D 1/2464; G05D 2109/10; G05D 2111/10; G05D 2111/32; G05D 2111/67

(57) ABSTRACT

Techniques are provide for generating occupancy grids based on inputs from multiple heterogeneous sensors. An example method for generating an occupancy grid includes obtaining detection information from a plurality of heterogeneous sensors, generating a single measurement grid based on the detection information from the plurality of heterogeneous sensors, determining occupancy probabilities for a plurality of cells in the single measurement grid, and outputting the occupancy grid based at least in part on the occupancy probabilities.

### CROSS-REFERENCE TO RELATED APPLICATIONS

This application claims the benefit of U.S. Provisional Application No. 63/594,579, filed Oct. 31, 2023, entitled “SENSOR MEASUREMENT GRID COMPLEXITY MANAGEMENT,” which is assigned to the assignee hereof, and the entire contents of which are hereby incorporated herein by reference for all purposes.

### BACKGROUND

Vehicles are becoming more intelligent as the industry moves towards deploying increasingly sophisticated self-driving technologies that are capable of operating a vehicle with little or no human input, and thus being semi-autonomous or autonomous. Autonomous and semi-autonomous vehicles may be able to detect information about their location and surroundings (e.g., using ultrasound, radar, lidar, an SPS (Satellite Positioning System), and/or an odometer, and/or one or more sensors such as accelerometers, cameras, etc.). Autonomous and semi-autonomous vehicles typically include a control system to interpret information regarding an environment in which the vehicle is disposed to identify hazards and determine a navigation path to follow. The control systems may be configured to compute occupancy grids based on the inputs of multiple sensors. Perception modules within the vehicles may be configured to utilize the occupancy grids for collision avoidance and navigation.

### SUMMARY

An example method for generating an occupancy grid according to the disclosure includes obtaining detection information from a plurality of heterogeneous sensors, generating a single measurement grid based on the detection information from the plurality of heterogeneous sensors, determining occupancy probabilities for a plurality of cells in the single measurement grid, and outputting the occupancy grid based at least in part on the occupancy probabilities.

Implementations of such a method may include one or more of the following features. Generating the single measurement grid may include combining the detection information in a single data buffer. The plurality of heterogeneous sensors may include a first radar configured to detect targets in a first area, and a second radar configured to detect targets in a second area that is different from the first area. The plurality of heterogeneous sensors may include a lidar and/or a camera. Obtaining the detection information may include receiving remote sensor detection information via a network interface. The occupancy probabilities may include an occupied probability and a free probability for each of the plurality of cells. The occupancy probabilities may include a dynamic probability and a static probability for each of the plurality of cells. The occupancy grid may include a grid cell state with a velocity indication for at least one of the plurality of cells.

An example apparatus according to the disclosure includes at least one memory, a plurality of heterogeneous sensors, at least one processor communicatively coupled to the at least one memory and the plurality of heterogeneous sensors, configured to: obtain detection information from the plurality of heterogeneous sensors, generate a single measurement grid based on the detection information from the plurality of heterogeneous sensors, compute occupancy probabilities for a plurality of cells in the single measurement grid, and output an occupancy grid based at least in part on the occupancy probabilities.

Items and/or techniques described herein may provide one or more of the following capabilities, as well as other capabilities not mentioned. Multiple sensors, such as cameras, radar and lidar, may obtain detection information for objects proximate to an autonomous or semi-autonomous vehicle. The detection information may be used to generate an occupancy grid. The detection information from multiple sensors may be combined into a single data buffer and plotted on a single measurement grid. Each cell in the single measurement grid may be analyzed to determine occupancy and/or free space probabilities. The analysis of the single measurement gird may require fewer processing cycles as compared to prior multi-grid techniques. Processes to fuse multiple sensor based occupancy grids may be eliminated. The reduction of processing cycles may reduce the latency associated with generating an occupancy grid. Object detection processes may be improved. Other capabilities may be provided and not every implementation according to the disclosure must provide any, let alone all, of the capabilities discussed.

### BRIEF DESCRIPTION OF THE DRAWINGS

FIG. 1 is a top view of an example ego vehicle.

FIG. 2 is a block diagram of components of an example device, of which the ego vehicle shown in FIG. 1 may be an example.

FIG. 3 is a block diagram of components of an example transmission/reception point.

FIG. 4 is a block diagram of components of a server.

FIG. 5 is a block diagram of an example device.

FIG. 6 is a diagram of an example geographic environment.

FIG. 7 is a diagram of the geographic environment shown in FIG. 6 divided into a grid.

FIG. 8 is an example of an occupancy map corresponding to the grid shown in FIG. 7.

FIG. 9 is a diagram of example detections obtained by a plurality of sensors on an ego vehicle.

FIG. 10A is a diagram of an example measurement grid based on a sensor detection frame.

FIG. 10B is a diagram of a process for determining occupancy and free space values for a sub-region in the example measurement grid of FIG. 10A.

FIG. 11 is a diagram of an example process for fusing a plurality of occupancy grids.

FIG. 12 is a diagram of an example process for determining occupancy and free space values for sub-regions in a single measurement grid.

FIG. 13 is a process flow diagram of an example method for generating an occupancy grid.

### DETAILED DESCRIPTION

Techniques are discussed herein for generating occupancy grids based on inputs from multiple sensors. Occupancy grids may play a critical role in robot Planning and navigation in local environments. A subset of occupancy grids are Dynamic Occupancy Grids (DOG) which are found in several applications such as autonomous driving, drone and humanoid navigation, augmented reality (AR) and virtual reality (VR) scene composition, and 3D reconstruction. Dynamic occupancy grids may include significantly richer information such as velocity of cells, and additional uncertainty estimates of states as compared to static occupancy grids. These features are often utilized in downstream object detection components as well as vehicle planning and control blocks. In an example, the sensor inputs for a DOG may be Lidar based only, Radar based only, Camera based only or a hybrid of these. A DOG may serve as a redundant path to downstream path planning blocks. In safety related use cases, such as autonomous and semi-autonomous driving, a redundant detection path may be beneficial when the performance of primary parametric approaches to perception (e.g., using objects) falters.

An occupancy grid is a non-parametric approach to representing an environment (e.g., area around a vehicle). Parametric approaches may utilize traditional sensor fusion to perform image recognition and generate parametric representations of detected objects. For example, proximate vehicle such as cars and trucks may be represented using parameters such as position, orientation, and size. In contrast, the non-parametric output of an occupancy grid, a proximate vehicle may be represented based on formations of grid cells along with velocity information in grid channels. In some implementations, occupancy grid algorithms may be configured to work on the lowest level of sensor data available. In an example, the occupancy grid algorithms may utilize a grid fusion step to ensure robustness from sensor noise occurring every instant. Grid fusion algorithms may be configured to work with underlying states to track the environment over time. These states may include Static, Dynamic, Free and a combination of these for uncertainty. The grid fusion algorithms may utilize different methods for tracking states of the grid. For example, Bayesian methods may be used for determining probability, and Dempster Shaffer theory may be utilized to determine belief and plausibility. Hidden Markov models may also be used to track states.

The grid fusion algorithms are generally applied on a per sensor basis such that a measurement grid is generated for each sensor frame. Occupancy and free space computations may be performed for each cell in the measurement grids. A collection of measurement grids, and the corresponding occupancy and free space computations, may be fused into a single combined grid. The creation of measurement grids per sensor frame, however, may require substantial processing power and thus may create latency issues for vehicle planning and control. The techniques provided herein may reduce the processing cycles required for generating an occupancy grid. In an example, detections from multiple sensor frames may be combined into a single data buffer, and the detections may be placed on a single measurement grid, rather than placing the detections on individual grids per sensor as in the prior grid fusion algorithms. Occupancy and free space computations may then be performed on the single measurement grid. Combining the detections on a single grid, prior to performing the occupancy and free space computations may reduce arithmetic and read-write operations as compared to prior fusion based processes. The reduction in processing requirements may reduce the latency required for generating an occupancy grid. Other techniques to reduce latency, however, may be used.

Particular aspects of the subject matter described in this disclosure may be implemented to realize one or more of the following potential advantages. Object detection performance based on the fusion of multiple sensors may be maintained, and the effectiveness of perception modules on a vehicle may be increased via a reduction in processing latency. Processing requirements for generating an occupancy grid (including a DOG) may be reduced, and corresponding power savings may be realized. Other advantages may also be realized.

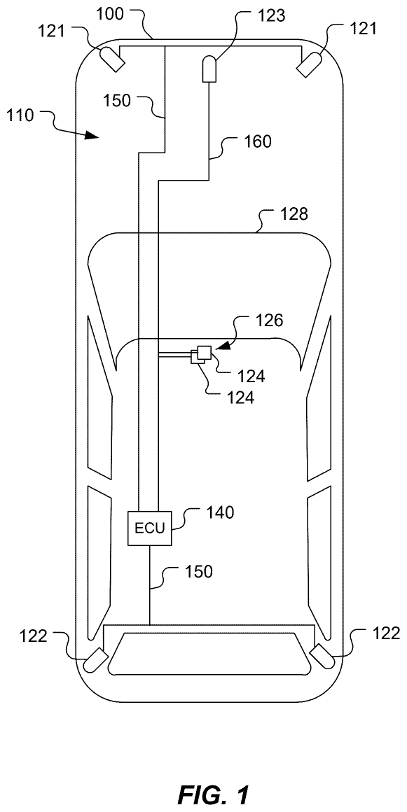

Referring to FIG. 1, an ego vehicle 100 includes an ego vehicle driver assistance system 110. The driver assistance system 110 may include a number of different types of sensors, i.e., heterogeneous sensors, mounted at appropriate positions on the ego vehicle 100. For example, the system 110 may include: a pair of divergent and outwardly directed radar sensors 121 mounted at respective front corners of the vehicle 100, a similar pair of divergent and outwardly directed radar sensors 122 mounted at respective rear corners of the vehicle 100, a forwardly directed LRR sensor 123 (Long-Range Radar) mounted centrally at the front of the vehicle 100, and a pair of generally forwardly directed optical sensors 124 (cameras) forming part of an SVS 126 (Stereo Vision System) which may be mounted, for example, in the region of an upper edge of a windshield 128 of the vehicle 100. Each of the sensors 121, 122 may include an LRR and/or an SRR (Short-Range Radar). The radar sensors 121, 122 and the optical sensors 124 are examples of heterogeneous sensors. The various sensors 121-124 may be operatively connected to a central electronic control system which is typically provided in the form of an ECU 140 (Electronic Control Unit) mounted at a convenient location within the vehicle 100. In the particular arrangement illustrated, the front and rear sensors 121, 122 are connected to the ECU 140 via one or more conventional Controller Area Network (CAN) buses 150, and the LRR sensor 123 and the sensors of the SVS 126 are connected to the ECU 140 via a serial bus 160 (e.g., a faster FlexRay serial bus).

Collectively, and under the control of the ECU 140, the various sensors 121-124 may be used to provide a variety of different types of driver assistance functionalities. For example, the sensors 121-124 and the ECU 140 may provide blind spot monitoring, adaptive cruise control, collision prevention assistance, lane departure protection, and/or rear collision mitigation.

The CAN bus 150 may be treated by the ECU 140 as a sensor that provides ego vehicle parameters to the ECU 140. For example, a GPS module may also be connected to the ECU 140 as a sensor, providing geolocation parameters to the ECU 140.

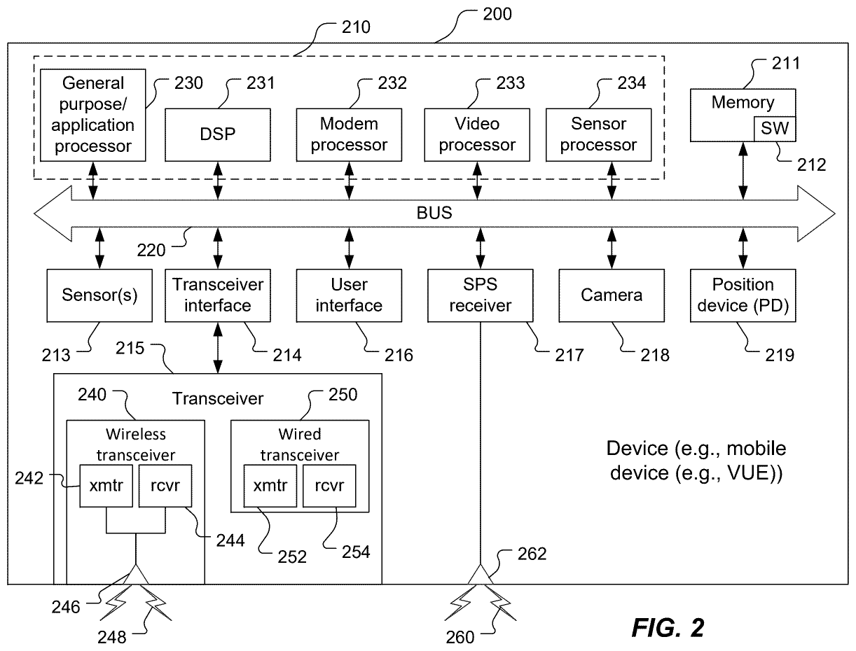

Referring also to FIG. 2, a device 200 (which may be a mobile device such as a user equipment (UE) such as a vehicle (VUE)) comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The terms “user equipment” or “UE” (or variations thereof) are not specific to or otherwise limited to any particular Radio Access Technology (RAT), unless otherwise noted. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the device 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the device 200 for connectivity. The memory 211 may be a non-transitory, processor-readable storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes instructions of software and/or firmware. The description herein may refer to the processor 210 performing a function as shorthand for one or more of the processors 230-234 performing the function. The description herein may refer to the device 200 performing a function as shorthand for one or more appropriate components of the device 200 performing the function. The processor 210 may include a memory with stored instructions in addition to and/or instead of the memory 211. Functionality of the processor 210 is discussed more fully below.

The configuration of the device 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The device 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The device 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the device 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the device 200 is fixed (stationary) or mobile and/or whether to report certain useful information, e.g., to an LMF (Location Management Function) regarding the mobility of the device 200. For example, based on the information obtained/measured by the sensor(s) 213, the device 200 may notify/report to the LMF that the device 200 has detected movements or that the device 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of the another object (e.g., another device) with respect to the device 200, etc.

The IMU may be configured to provide measurements about a direction of motion and/or a speed of motion of the device 200, which may be used in relative location determination. For example, one or more accelerometers and/or one or more gyroscopes of the IMU may detect, respectively, a linear acceleration and a speed of rotation of the device 200. The linear acceleration and speed of rotation measurements of the device 200 may be integrated over time to determine an instantaneous direction of motion as well as a displacement of the device 200. The instantaneous direction of motion and the displacement may be integrated to track a location of the device 200. For example, a reference location of the device 200 may be determined, e.g., using the SPS receiver 217 (and/or by some other means) for a moment in time and measurements from the accelerometer(s) and gyroscope(s) taken after this moment in time may be used in dead reckoning to determine present location of the device 200 based on movement (direction and distance) of the device 200 relative to the reference location.

The magnetometer(s) may determine magnetic field strengths in different directions which may be used to determine orientation of the device 200. For example, the orientation may be used to provide a digital compass for the device 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to guided (e.g., wired electrical and/or optical) signals and from guided (e.g., wired electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. New Radio may use mm-wave frequencies and/or sub-6 GHZ frequencies. The wired transceiver 250 may include a wired transmitter 252 and a wired receiver 254 configured for wired communication, e.g., a network interface that may be utilized to communicate with an NG-RAN (Next Generation-Radio Access Network) to send communications to, and receive communications from, the NG-RAN. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the device 200. For example, the user interface 216 may store indications of analog and/or digital signals in the memory 211 to be processed by DSP 231 and/or the general-purpose/application processor 230 in response to action from a user. Similarly, applications hosted on the device 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to guided signals, e.g., wired electrical or optical signals, and may be integrated with the antenna 246. The SPS receiver 217 may be configured to process, in whole or in part, the acquired SPS signals 260 for estimating a location of the device 200. For example, the SPS receiver 217 may be configured to determine location of the device 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the device 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the device 200.

The device 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the device 200, motion of the device 200, and/or relative position of the device 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the device 200 using terrestrial-based signals (e.g., at least some of the wireless signals 248) for trilateration, for assistance with obtaining and using the SPS signals 260, or both. The PD 219 may be configured to determine location of the device 200 based on a coverage area of a serving base station and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the device 200. The PD 219 may be configured to use one or more other techniques (e.g., relying on the UE's self-reported location (e.g., part of the UE's position beacon)) for determining the location of the device 200, and may use a combination of techniques (e.g., SPS and terrestrial positioning signals) to determine the location of the device 200. The PD 219 may include one or more of the sensors 213 (e.g., gyroscope(s), accelerometer(s), magnetometer(s), etc.) that may sense orientation and/or motion of the device 200 and provide indications thereof that the processor 210 (e.g., the general-purpose/application processor 230 and/or the DSP 231) may be configured to use to determine motion (e.g., a velocity vector and/or an acceleration vector) of the device 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the device 200, and may be provided by hardware, software, firmware, or various combinations thereof.

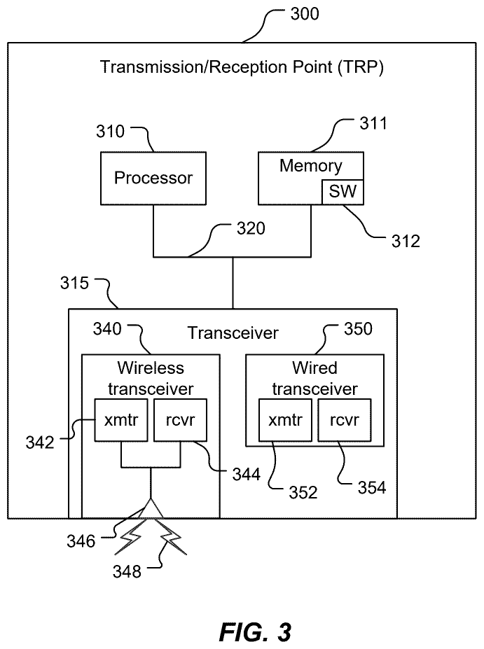

Referring also to FIG. 3, an example of a TRP 300 (e.g., of a base station such as a gNB (general NodeB) and/or an ng-eNB (next generation evolved NodeB) may comprise a computing platform including a processor 310, memory 311 including software (SW) 312, and a transceiver 315. Even if referred to in the singular, the processor 310 may include one or more processors, the transceiver 315 may include one or more transceivers (e.g., one or more transmitters and/or one or more receivers), and/or the memory 311 may include one or more memories. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 may be a non-transitory storage medium that may include random access memory (RAM)), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 311) of the TRP 300 performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to guided (e.g., wired electrical and/or optical) signals and from guided (e.g., wired electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the device 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 350 may include a wired transmitter 352 and a wired receiver 354 configured for wired communication, e.g., a network interface that may be utilized to communicate with an NG-RAN to send communications to, and receive communications from, an LMF, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by an LMF and/or the device 200 (i.e., an LMF and/or the device 200 may be configured to perform one or more of these functions).

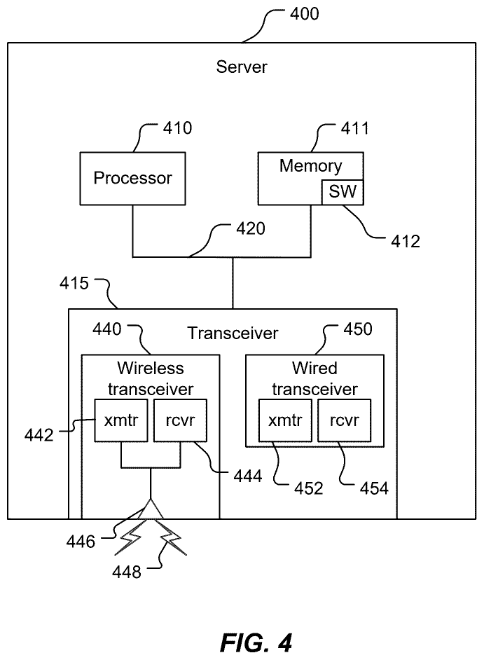

Referring also to FIG. 4, a server 400, of which an LMF is an example, may comprise a computing platform including a processor 410, memory 411 including software (SW) 412, and a transceiver 415. Even if referred to in the singular, the processor 410 may include one or more processors, the transceiver 415 may include one or more transceivers (e.g., one or more transmitters and/or one or more receivers), and/or the memory 411 may include one or more memories. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 may be a non-transitory storage medium that may include random access memory (RAM)), flash memory, disc memory, and/or read-only memory (ROM), etc. The memory 411 may store the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to guided (e.g., wired electrical and/or optical) signals and from guided (e.g., wired electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the device 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 450 may include a wired transmitter 452 and a wired receiver 454 configured for wired communication, e.g., a network interface that may be utilized to communicate with an NG-RAN to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the device 200 (i.e., the TRP 300 and/or the device 200 may be configured to perform one or more of these functions).

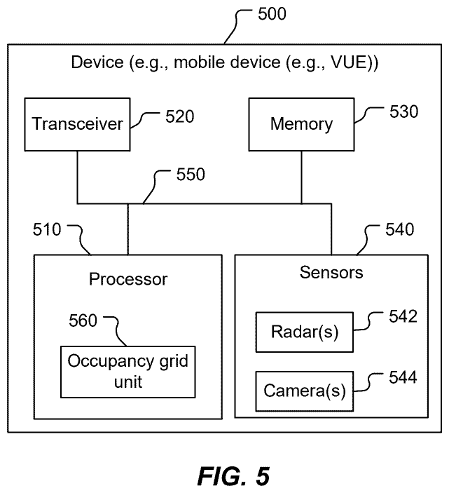

Referring to FIG. 5, a device 500 includes a processor 510, a transceiver 520, a memory 530, and sensors 540, communicatively coupled to each other by a bus 550. Even if referred to in the singular, the processor 510 may include one or more processors, the transceiver 520 may include one or more transceivers (e.g., one or more transmitters and/or one or more receivers), and the memory 530 may include one or more memories. The device 500 may take any of a variety of forms such as a mobile device such as a vehicle UE (VUE). The device 500 may include the components shown in FIG. 5, and may include one or more other components such as any of those shown in FIG. 2 such that the device 200 may be an example of the device 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions. The sensors 540 include heterogeneous sensors such as one or more radar sensors 542 and one or more cameras 544. The sensors 540 may include one or more other types of sensors, such as lidar, Hall-effect, and/or ultrasound sensor(s), and/or one or more other types of sensors configured to assist vehicle operations.

The description herein may refer to the processor 510 performing a function, but this includes other implementations such as where the processor 510 executes software (stored in the memory 530) and/or firmware. The description herein may refer to the device 500 performing a function as shorthand for one or more appropriate components (e.g., the processor 510 and the memory 530) of the device 500 performing the function. The processor 510 (possibly in conjunction with the memory 530 and, as appropriate, the transceiver 520) may include an occupancy grid unit 560 (which may include an ADAS (Advanced Driver Assistance System) for a VUE). The occupancy grid unit 560 is discussed further herein, and the description herein may refer to the occupancy grid unit 560 performing one or more functions, and/or may refer to the processor 510 generally, or the device 500 generally, as performing any of the functions of the occupancy grid unit 560, with the device 500 being configured to perform the functions.

One or more functions performed by the device 500 (e.g., the occupancy grid unit 560) may be performed by another entity. For example, sensor measurements (e.g., radar measurements, camera measurements (e.g., pixels, images)) and/or processed sensor measurements (e.g., a camera image converted to a bird's-eye-view image) may be provided to another entity, e.g., the server 400, and the other entity may perform one or more functions discussed herein with respect to the occupancy grid unit 560 (e.g., using machine learning to determine a present occupancy grid and/or applying an observation model, analyzing measurements from different sensors, to determine a present occupancy grid, etc.).

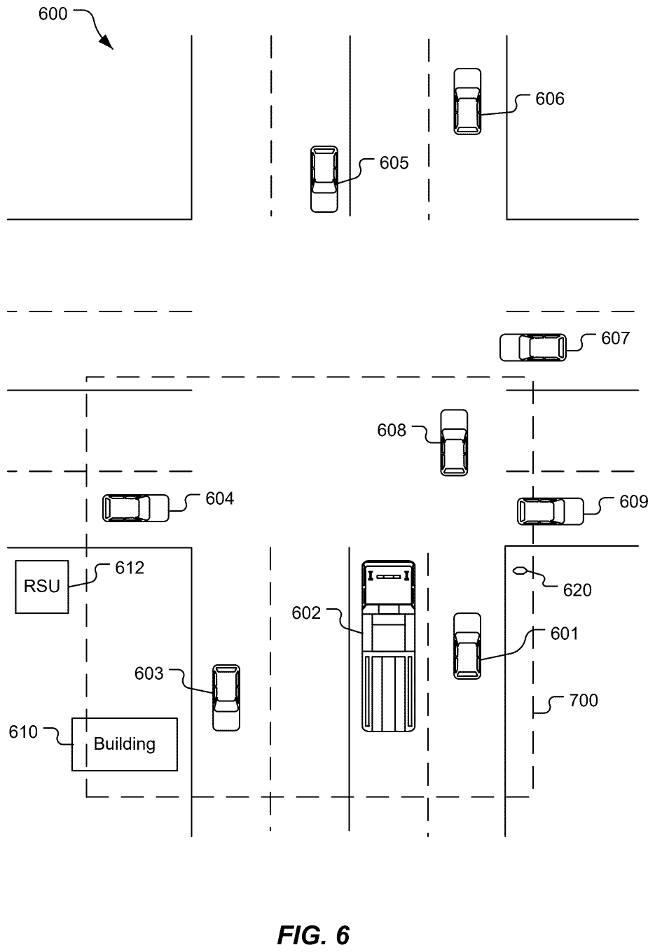

Referring also to FIG. 6, a geographic environment 600, in this example a driving environment, includes multiple mobile wireless communication devices, here vehicles 601, 602, 603, 604, 605, 606, 607, 608, 609, a building 610, an RSU 612 (Roadside Unit), and a street sign 620 (e.g., a stop sign). The RSU 612 may be configured similarly to the TRP 300, although perhaps having less functionality and/or shorter range than the TRP 300, e.g., a base-station-based TRP. One or more of the vehicles 601-609 may be configured to perform autonomous driving. A vehicle whose perspective is under consideration (e.g., for environment evaluation, autonomous driving, etc.) may be referred to as an observer vehicle or an ego vehicle. An ego vehicle, such as the vehicle 601 may evaluate a region around the ego vehicle for one or more desired purposes, e.g., to facilitate autonomous driving. The vehicle 601 may be an example of the device 500. The vehicle 601 may divide the region around the ego vehicle into multiple sub-regions and evaluate whether an object occupies each sub-region and if so, may determine one or more characteristics of the object (e.g., size, shape (e.g., dimensions (possibly including height)), velocity (speed and direction), object type or class (bicycle, car, truck, etc.), etc.).

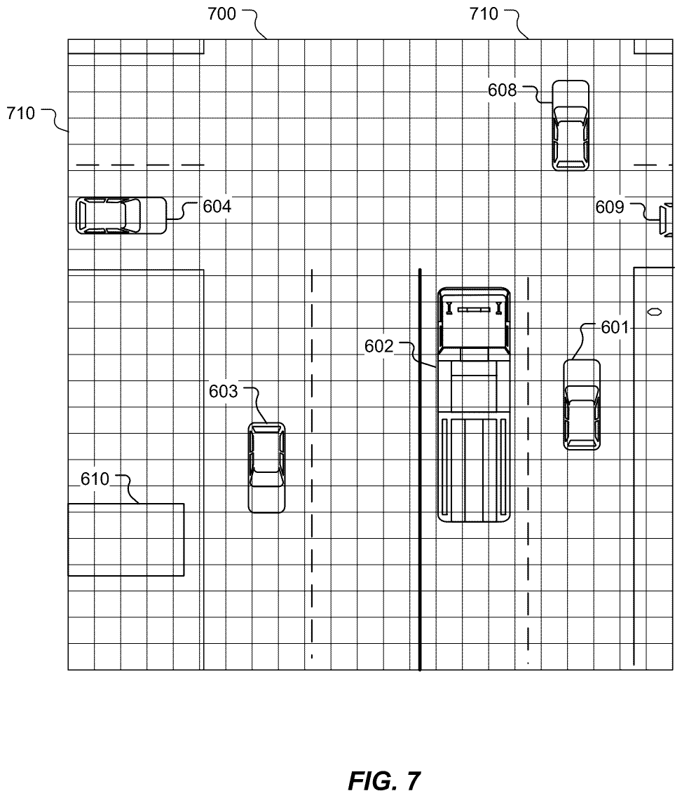

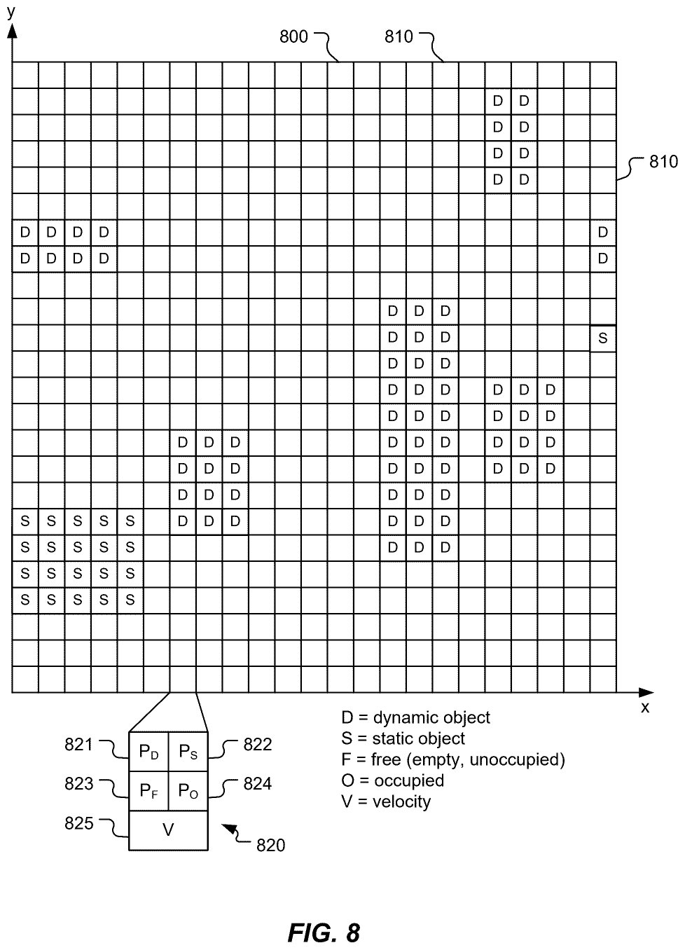

Referring also to FIGS. 7 and 8, a region 700, which in this example spans a portion of the environment 600, may be evaluated to determine an occupancy grid 800 (also called an occupancy map) that indicates multiple probabilities for each cell of the grid 800 whether the cell is occupied or free, and whether an occupying object is static or dynamic. For example, the region 700 may be divided into a grid, which may be called an occupancy grid, with sub-regions 710 that may be of similar (e.g., identical) size and shape, or may have two or more sizes and/or shapes (e.g., with sub-regions being smaller near an ego vehicle, e.g., the vehicle 601, and larger further away from the ego vehicle, and/or with sub-regions having different shape(s) near an ego vehicle than sub-region shape(s) further away from the ego vehicle). The region 700 and the grid 800 may be regularly-shaped (e.g., a rectangle, a triangle, a hexagon, an octagon, etc.) and/or may be divided into identically-shaped, regularly-shaped sub-regions for convenience sake, e.g., to simplify calculations, but other shapes of regions/grids (e.g., an irregular shape) and/or sub-regions (e.g., irregular shapes, multiple different regular shapes, or a combination of one or more irregular shapes and one or more regular shapes) may be used. For example, the sub-regions 710 may have rectangular (e.g., square) shapes. The region 700 may be of any of a variety of sizes and have any of a variety of granularities of sub-regions. For example, the region 700 may be a rectangle (e.g., a square) of about 100 m per side. As another example, while the region 700 is shown with the sub-regions 710 being squares of about 1 m per side, other sizes of sub-regions, including much smaller sub-regions, may be used. For example, square sub-regions of about 25 cm per side may be used. In this example, the region 700 is divided into M rows (here, 24 rows parallel to an x-axis indicated in FIG. 8) of N columns each (here, 23 columns parallel to a y-axis as indicated in FIG. 8). As another example, a grid may comprise a 512×512 array of sub-regions. Still other implementations of occupancy grids may be used.

Each of the sub-regions 710 may correspond to a respective cell 810 of the occupancy map and information may be obtained regarding what, if anything, occupies each of the sub-regions 710 and whether an occupying object is static or dynamic in order to populate cells 810 of the occupancy grid 800 with probabilities of the cell being occupied (O) or free (F) (i.e., unoccupied), and probabilities of an object at least partially occupying a cell being static(S) or dynamic (D). Each of the probabilities may be a floating point value. The information as to what, if anything, occupies each of the sub-regions 710 may be obtained from a variety of sources. For example, occupancy information may be obtained from sensor measurements from the sensors 540 of the device 500. As another example, occupancy information may be obtained by one or more other devices and communicated to the device 500. For example, one or more of the vehicles 602-609 may communicate, e.g., via C-V2X communications, occupancy information to the vehicle 601. As another example, the RSU 612 may gather occupancy information (e.g., from one or more sensors of the RSU 612 and/or from communication with one or more of the vehicles 602-609 and/or one or more other devices) and communicate the gathered information to the vehicle 601, e.g., directly and/or through one or more network entities, e.g., TRPs.

As shown in FIG. 8, each of the cells 810 may include a set 820 of occupancy information indicating a dynamic probability 821 (P_{D}), a static probability 822 (P_{S}), a free probability 823 (P_{F}), an occupied probability 824 (P_{P}), and a velocity 825 (V). The dynamic probability 821 indicates a probability that an object (if any) in the corresponding sub-region 710 is dynamic. The static probability 822 indicates a probability that an object (if any) in the corresponding sub-region 710 is static. The free probability 823 indicates a probability that there is no object in the corresponding sub-region 710. The occupied probability 824 indicates a probability that there is an object in (any portion of) the corresponding sub-region 710. Each of the cells 810 may include respective probabilities 821-824 of an object corresponding to the cell 810 being dynamic, static, absent, or present, with a sum of the probabilities being 1. In the example shown in FIG. 8, cells more likely to be free (empty) than occupied are not labeled in the occupancy grid 800 for sake of simplicity of the figure and readability of the occupancy grid 800. Also as shown in FIG. 8, cells more likely to be occupied than free, and occupied by an object that is more likely to be dynamic than static are labeled with a “D”, and cells more likely to be occupied than free, and occupied by an object that is more likely to be static than dynamic are labeled with a “S”. An ego vehicle may not be able to determine whether a cell is occupied or not (e.g., being behind a visible surface of an object and not discernable based on an observed object (e.g., if the size and shape of a detected object is unknown)), and such a cell may be labeled as unknown occupancy.

Building a dynamic occupancy grid (an occupancy grid with a dynamic occupier type) may be helpful, or even essential, for understanding an environment (e.g., the environment 600) of an apparatus to facilitate or even enable further processing. For example, a dynamic occupancy grid may be helpful for predicting occupancy, for motion planning, etc. A dynamic occupancy grid may, at any one time, comprise one or more cells of static occupier type and/or one or more cells of dynamic occupier type. A dynamic object may be represented as a set of one or more velocity vectors. For example, an occupancy grid cell may have some or all of the occupancy probability be dynamic, and within the dynamic occupancy probability, there may be multiple (e.g., four) velocity vectors each with a corresponding probability that together sum to the dynamic occupancy probability for that cell 810. A dynamic occupancy grid may be obtained, e.g., by the occupancy grid unit 560, by processing information from multiple sensors, e.g., of the sensors 540, such as from a radar system. Adding data from one or more cameras to determine the dynamic occupancy grid may provide significant improvements to the grid, e.g., accuracy of probabilities and/or velocities in grid cells.

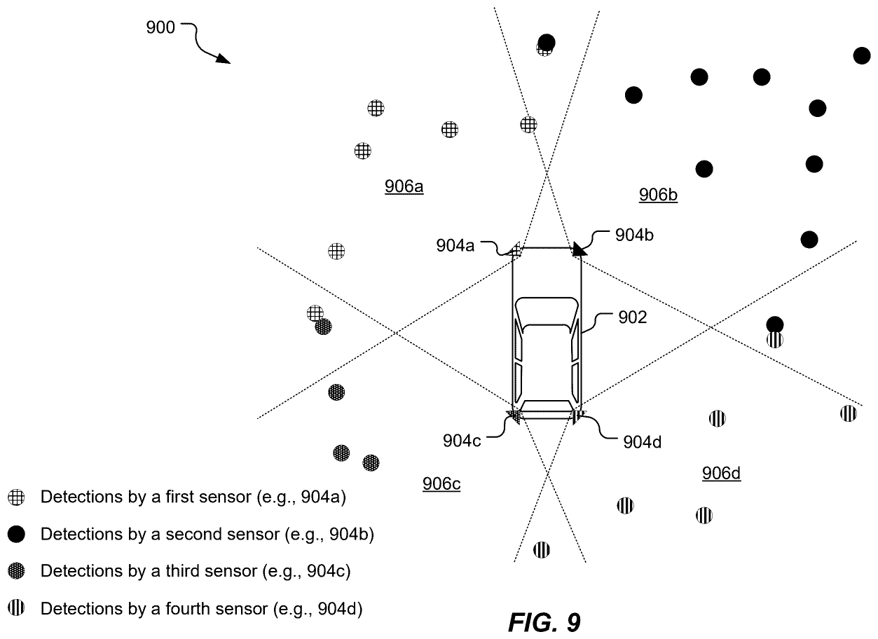

Referring to FIG. 9, a diagram of example detections 900 obtained by a plurality of sensors on an ego vehicle 902 is shown. The ego vehicle 902 may have some or all of the features of the ego vehicle 100, and the ego vehicle 100 is an example of the ego vehicle 902. The ego vehicle 902 includes a plurality of sensors, such as a first sensor 904a, a second sensor 904b, a third sensor 904c, and a fourth sensor 904d, configured to generate the detections 900 which represent objects in an environment proximate to the ego vehicle 902. In an example, the first sensor 904a and the second sensor 904b may be the outwardly directed radar sensors 121, and the third sensor 904c and the fourth sensor 904d may be the outwardly directed radar sensors 122. Other sensors on the ego vehicle 902 may be used to generate the detections 900 (e.g., the LRR 123, the optical sensors 124/SVS 126, etc.). Each of the sensors 904a-904d may be configured to obtain detection information in a portion of the environment around the vehicle 902. For example, the first sensor 904a may be configured to obtain detection information in a first area 906a, and the second, third, and fourth sensors 904b, 904c, 904d may obtain object detection information in respective second, third and fourth areas 906b, 906c, 906d. An object may be detected by multiple sensors based on the overlapping areas covered by the sensors. The detections 900 represent the detection information provided by each of the multiple sensors 904a-904d within a unit of time and processed by the ECU 140. The unit of time may be referred to as a frame, and each frame may have a predetermined duration (e.g., 20 msec, 40 msec, 100 msec, etc.). Each of the detections 900 may indicate a point in space in which one or more of the sensor detects an object. The point in space may be defined by a range and bearing from the sensor(s). The ECU 140, or other processing system (e.g., the processors 510 in the device 500), may be configured to utilize the detections 900 in a detection frame to determine the occupancy and free space values, such as described with respect to FIG. 8, for cells in a grid area around the ego vehicle 902.

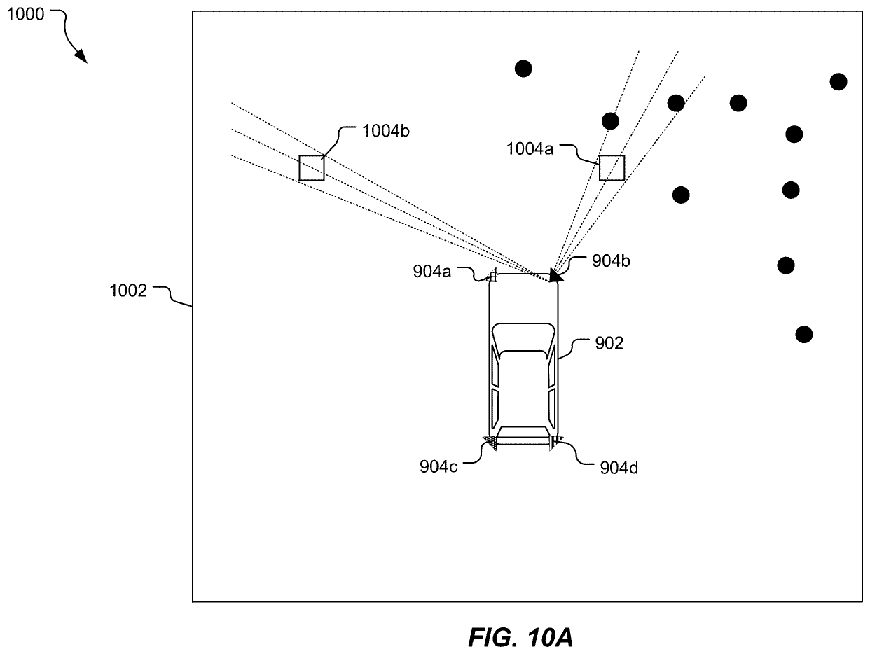

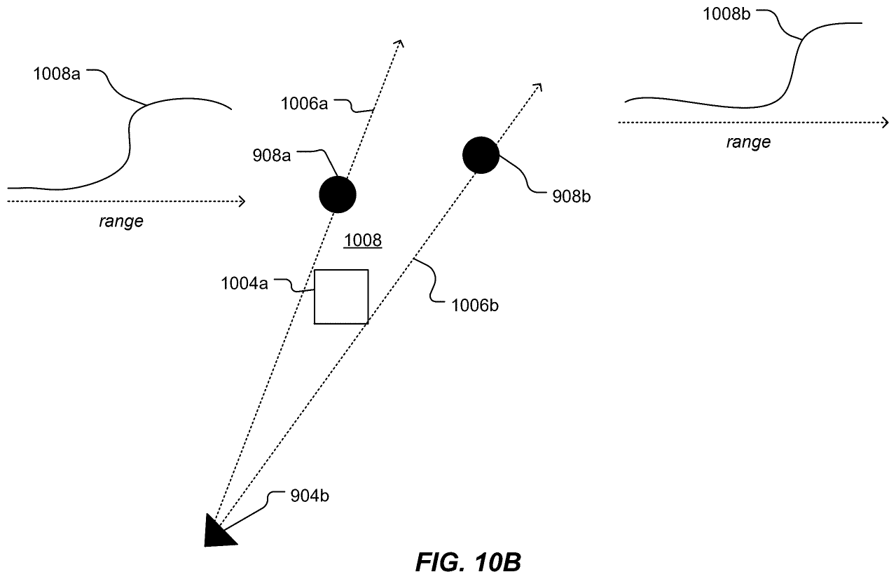

Referring to FIG. 10A, with further reference to FIG. 8 and FIG. 9, an example measurement grid 1000 based on a sensor detection frame is shown. The measurement grid 1000 may be used to compute an occupancy grid (e.g., as described with respect to FIG. 8) by dividing a region 1002 into a number of sub-regions. For example, the sub-regions include a first sub-region 1004a and a second sub-region 1004b. The sub-regions 1004a, 1004b are examples to demonstrate a process for estimating occupancy and free space for the corresponding cells in the resulting occupancy grid. As used herein, an occupancy grid is the result of performing occupancy and free space analysis on the detections in the sub-regions of a measurement grid. The sub-regions become the cells in the resulting occupancy grid. In operation, the ECU 140 may be configured to process each detection frame obtained from each of the respective sensors 904a-904d. A measurement grid is created for each sensor detection frame. A process for creating an occupancy grid may include using an inverse sensor model for a particular sensor. The process may generate occupancy and free space estimates based on the relevant detections 900 in the region 1002. Velocities of detections may also be used as velocity of cells (e.g., the velocity 825 (V)). The processing for each sub-region (e.g., grid cell) may be independent of the rest of the grid.

Referring to FIG. 10B, an example process for determining occupancy and free space values for the first sub-region 1004a is shown. The process determines the probabilities for occupancy and free space as described with respect to FIG. 8 (e.g., the free probability 823 (P_{F}), and the occupied probability 824 (P_{P})). In an example process, a conic type area 1008 emanating from the sensor 904b may be computed for each sub-region (e.g., cell) in a region (e.g., the measurement grid), and the detections that are within or proximate to the conic type area 1008 are identified as relevant detections for that cell. For example, the conic type area 1008 is generated based on the location of the second sensor 904b, the first sub-region 1004a, a first tangent line 1006a, and a second tangent line 1006b. The tangent lines 1006a, 1006b intersect the outermost parameter of the first sub-region on the respective sides as depicted in FIG. 10B. The conic type area 1008 is the area between the tangent lines 1006a, 1006b. A first detection 908a and a second detection 908b are relevant detections to the first sub-region 1004a. In general, statistical representations of detections may be analyzed to determine a probability that the detection is within a sub-region. For example, gaussian representations of the range and bearing of the detections 908a, 908b may be compared to the location of the first sub-region 1004a to determine respective probabilities of occupancy, such as illustrated in a first probability plot 1008a and a second probability plot 1008b. In an example, the probabilities of occupancy for each relevant detection may be combined to generate a probability of occupancy for a cell. In an example, a maximum probability of occupancy value for the relevant detections may be used as the probability of occupancy for the cell. Other techniques for determining the probability of occupancy for a cell in measurement grid may be used. Similar procedures for determining whether a cell is free space may also be used.

The process described with respect to FIG. 10B may be iterated for each sub-region in the region 1002 to generate an occupancy grid for each sensor frame. For example, the process will be performed on the second sub-region 1004b even though the second sub-region 1004b is outside of the second area 906b (e.g., outside of the expected detection coverage area of the second sensor 904b). The relevant detections of a single detection frame are used to create the particular sensor frame occupancy grid. In this process, independent measurement grids are generated for each sensor frame. That is, the process is repeated for the detections obtained by the first, third and fourth sensors 904a, 904c, 904d.

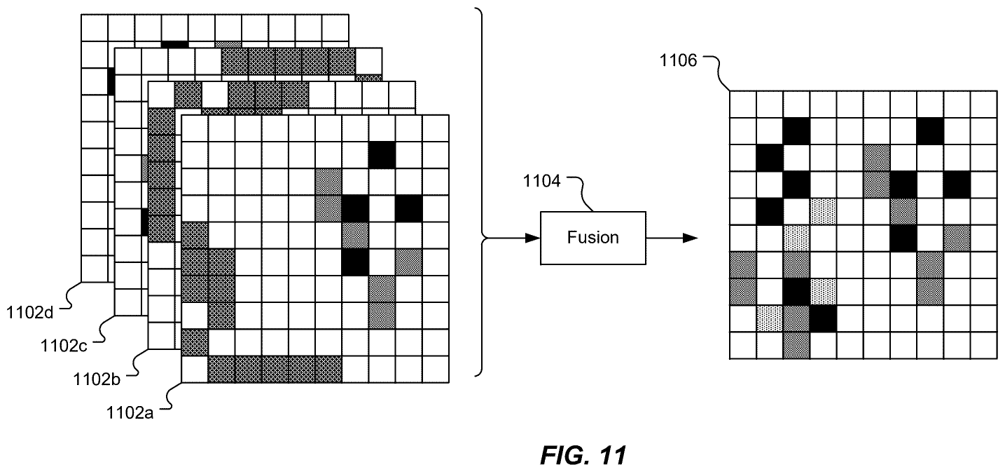

Referring to FIG. 11, an example process for fusing a plurality of occupancy grids is shown. In an example, generating a common occupancy grid 1106 based on a plurality of sensor inputs may be a two-step process. In a first step, a plurality of occupancy grids are generated for each sensor frame based on the procedures described with respect to FIGS. 10A and 10B. For example, a first occupancy grid 1102a is generated based on a sensor frame obtained by the first sensor 904a, a second occupancy grid 1102b is generated based on a sensor frame obtained by the second sensor 904b, a third occupancy grid 1102c is generated based on a sensor frame obtained by the third sensor 904c, and a fourth occupancy grid 1102d is generated based on a sensor frame obtained by the fourth sensor 904d. Each of the cells in each the occupancy grids 1102a-1002d includes an estimated occupancy value based on the relevant detections, and an estimated frees space value based on relevant detections. Velocities of detections may be used as velocity of cells.

In a second step, a fusion process 1104 is performed to fuse the individual occupancy grids 1102a-1002d into the common occupancy grid 1106. The occupancy values and free space values for the cells in the common occupancy grid 1106 may be based on averaging the probabilities associated with each of the respective cells. In an example, a maximum function may be used to determine the occupancy and free space values. The creation of the multiple occupancy grids 1102a-1002d per sensor frame may require substantial processing power and may create latency in the object detection process. In an example, the factors which may impact latency include the load placed on the arithmetic block and the memory read-write block in a processing architecture. In operation, the ECU 140 may be required to perform a repetitive number of computations on the cells to generate the occupancy grids 1102a-1002d, which may significantly increase the processing latency of the occupancy grid algorithm.

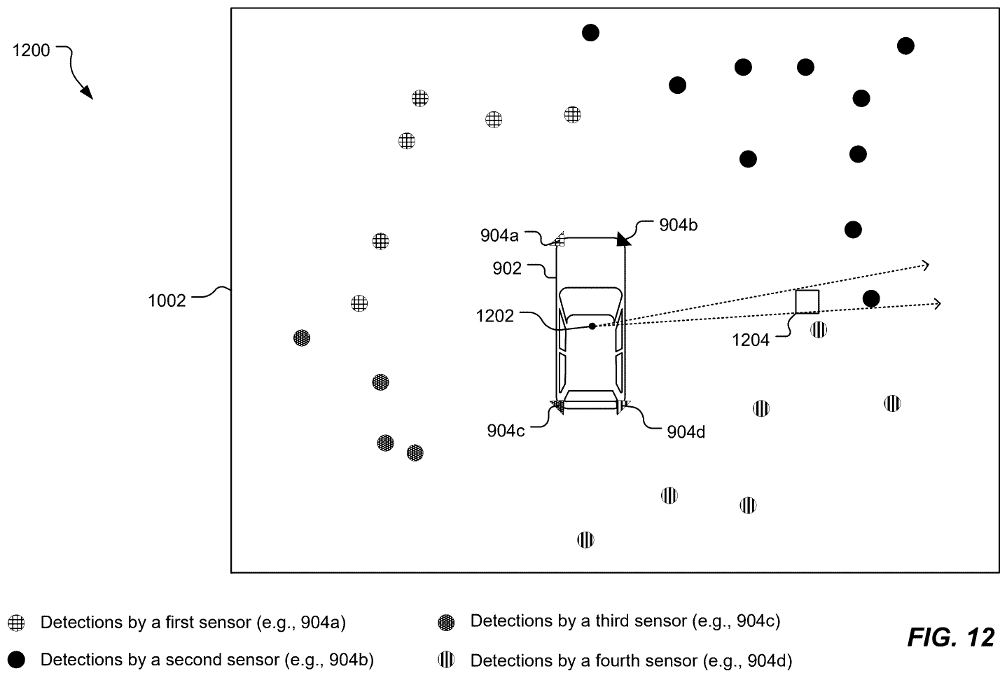

Referring to FIG. 12, with further reference to FIG. 9 and FIG. 10, an example process for determining occupancy and free space values for sub-regions in a single measurement grid 1200 is shown. An occupancy grid based on detections 900 obtained from the plurality of sensors 904a-904d may be generated by combining all the detections 900 from all sensor frames into a single data buffer, and placing them on the single measurement grid 1200, instead of placing them on individual grids per sensor. The process for determining occupancy and free space values as described with respect to FIGS. 10A and 10B may be implemented for each sub-region in the region 1002. In an example, the detections 900 obtained in each sensor frame for each of the sensors 904a-904d may be plotted on the single measurement grid 1200. An origin transformation may be utilized to transpose the coordinates of the detections from the respective sensors 904a-904d to a common origin 1202. In an example, the common origin 1202 may be based on a centerline of the ego vehicle 902. The process for determining occupancy and free space values as described with respect to FIG. 10B may be performed on each of the sub-regions in the measurement grid 1200 based on the common origin 1202. For example, a conic type area is depicted in FIG. 12 based on a first sub-region 1204 and the common origin 1202. This process is repeated for each of the sub-regions in the region 1002.

Combining the detections 900 into the signal measurement grid 1200 and then determining occupancy and free space values for each of the sub-regions in the single grid is a substantial reduction in processing requirements as compared to determining occupancy and free space values for each of the sub-regions in the multiple measurement grids, and then fusing the resulting occupancy grids as described with respect to FIG. 11. Processing the single measurement grid 1200 reduces the load placed on the arithmetic block and the memory read-write block in the processing architecture, and eliminates the fusion process 1104. As a result, the processing latency of the occupancy grid algorithm may be significantly reduced. In an example, multiple occupancy grids from consecutive frames may be analyzed to generate dynamic and static probabilities for the cells.

The detections obtained by the sensors 904a-904d shown on the single measurement grid 1200 are examples, and not limitations, as detections from other sensors (e.g., lidar, camera, ultrasound, etc.) may also be included on the single measurement grid 1200 and included in the occupancy and free space computations as described with respect to FIGS. 10A and 10B.

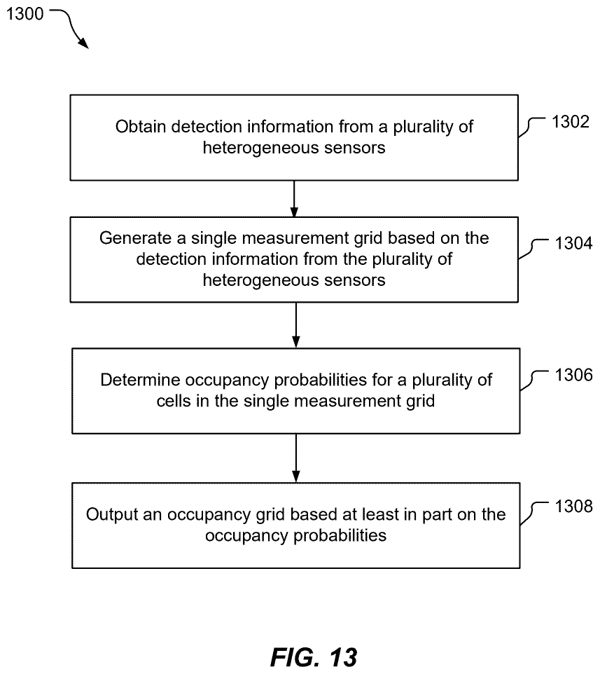

Referring to FIG. 13, with further reference to FIGS. 1-12, a method 1300 for generating an occupancy grid includes the stages shown. The method 1300 is, however, an example and not limiting. The method 1300 may be altered, e.g., by having one or more stages added, removed, rearranged, combined, performed concurrently, and/or having one or more stages each split into multiple stages.

At stage 1302, the method 1300 includes obtaining detection information from a plurality of sensors. A device 500, including the processor 510 and the sensors 540, are a means for obtaining the detection information. An ego vehicle may include a plurality of heterogeneous sensors configured to obtain detections such as described with respect to FIG. 9. In an example, the detection information may include a distance (e.g., range) and angle (e.g., bearing) to a detected object relative to the sensor. The plurality of heterogeneous sensors may include any or all of the sensors 540, such as radars 542 and cameras 544. Other sensors, such as a lidar, ultrasound, infrared detectors, hall effect sensors, etc. may be configured to obtain detection information for environments around the ego vehicle. In an example, detection information obtained by remote sensors (e.g., not on the ego vehicle) may be obtained by the ego vehicle via a network interface. For example, the detection information may be remote sensor detection information obtained from a roadside unit (RSU) or proximate vehicle via a V2X interface such as the Uu and/or the PC5 interface.

At stage 1304, the method 1300 includes generating a single measurement grid based on the detection information from the plurality of heterogeneous sensors. The device 500, including the processor 510 and the memory 530, is a means for generating the single measurement grid. In an example, referring to FIG. 12, the detections 900 obtained in each sensor frame for each of the sensors 904a-904d may be plotted on the single measurement grid 1200. Coordinates of detections in the detection information obtained from the plurality of sensors may be plotted relative to a common origin 1202. In an example, the detection information may be combined into a single data buffer in the memory 530.

At stage 1306, the method 1300 includes determining occupancy probabilities for a plurality of cells in the single measurement grid. The device 500, including the processor 510 and the memory 530, is a means for determining the occupancy probabilities. In an example, referring to FIG. 8, each of the plurality of cells may include a set 820 of occupancy information indicating a free probability 823 (P_{F}), and an occupied probability 824 (P_{P}). Occupancy grids generated from other sensor frames (e.g., at different times) may be used to generate other information such as a dynamic probability 821 (P_{D}), a static probability 822 (P_{S}), and/or a velocity 825 (V). The occupancy and free space probability values may be computed based on analyzing the detections within a conic type area defined by the common origin 1202 and the perimeter of a sub-region/cell being evaluated (e.g., the first sub-region 1204). Other occupancy and free space analysis algorithms may also be used with the single measurement grid to compute the occupancy probabilities.

At stage 1308, the method 1300 includes outputting an occupancy grid based at least in part on the occupancy probabilities. The device 500, including the processor 510 and the transceiver 520, is a means for outputting the occupancy grid. In an example, referring to FIG. 8, the occupancy grid may include respective occupancy probabilities (e.g., probabilities 821-824) of an object. The cells more likely to be free than empty are not labeled in the occupancy grid 800 for sake of simplicity of the figure and readability of the occupancy grid 800, and cells more likely to be occupied than free, and occupied by an object that is more likely to be dynamic than static are labeled with a “D”, and cells more likely to be occupied than free, and occupied by an object that is more likely to be static than dynamic are labeled with a “S”. An ego vehicle may not be able to determine whether a cell is occupied or not (e.g., being behind a visible surface of an object and not discernable based on an observed object (e.g., if the size and shape of a detected object is unknown)), and such a cell may be labeled as unknown occupancy. Other occupancy probabilities may be used to define the cells in the occupancy grid.

### Implementation Examples

Implementation examples are provided in the following numbered clauses.

Clause 1. A method for generating an occupancy grid, comprising:
obtaining detection information from a plurality of heterogeneous sensors;
generating a single measurement grid based on the detection information from the plurality of heterogeneous sensors;
determining occupancy probabilities for a plurality of cells in the single measurement grid; and
outputting the occupancy grid based at least in part on the occupancy probabilities.

Clause 2. The method of clause 1 wherein generating the single measurement grid includes combining the detection information in a single data buffer.

Clause 3. The method of either clause 1 or clause 2 wherein the plurality of heterogeneous sensors includes a first radar configured to detect targets in a first area, and a second radar configured to detect targets in a second area that is different from the first area.

Clause 4. The method of any of clauses 1-3 wherein the plurality of heterogeneous sensors includes a lidar.

Clause 5. The method of any of clauses 1-4 wherein the plurality of heterogeneous sensors includes a camera.

Clause 6. The method of any of clauses 1-5 wherein obtaining the detection information includes receiving remote sensor detection information via a network interface.

Clause 7. The method of any of clauses 1-6 wherein the occupancy probabilities include an occupied probability and a free probability for each of the plurality of cells.

Clause 8. The method of any of clauses 1-7 wherein the occupancy probabilities include a dynamic probability and a static probability for each of the plurality of cells.

Clause 9. The method of any of clauses 1-8 wherein the occupancy grid includes a grid cell state with a velocity indication for at least one of the plurality of cells.

Clause 10. An apparatus, comprising:
at least one memory;
a plurality of heterogeneous sensors;
at least one processor communicatively coupled to the at least one memory and the plurality of heterogeneous sensors, configured to:
   obtain detection information from the plurality of heterogeneous sensors;
   generate a single measurement grid based on the detection information from the plurality of heterogeneous sensors;
   compute occupancy probabilities for a plurality of cells in the single measurement grid; and
   output an occupancy grid based at least in part on the occupancy probabilities.

Clause 11. The apparatus of clause 10 wherein the at least one processor is further configured to combine the detection information in a single data buffer in the at least one memory.

Clause 12. The apparatus of either clause 10 or clause 11 wherein the plurality of heterogeneous sensors includes a first radar configured to detect targets in a first area, and a second radar configured to detect targets in a second area that is different from the first area.

Clause 13. The apparatus any of clauses 10-12 wherein the plurality of heterogeneous sensors includes a lidar.

Clause 14. The apparatus of any of clauses 10-13 wherein the plurality of heterogeneous sensors includes a camera.

Clause 15. The apparatus of any of clauses 10-14 wherein the at least one processor is further configured to receive remote sensor detection information via a network interface.

Clause 16. The apparatus of any of clauses 10-15 wherein the occupancy probabilities include an occupied probability and a free probability for each of the plurality of cells.

Clause 17. The apparatus of any of clauses 10-16 wherein the occupancy probabilities include a dynamic probability and a static probability for each of the plurality of cells.

Clause 18. The apparatus of any of clauses 10-17 wherein the occupancy grid includes a grid cell state with a velocity indication for at least one of the plurality of cells.

Clause 19. An apparatus for generating an occupancy grid, comprising:
means for obtaining detection information from a plurality of heterogeneous sensors;
means for generating a single measurement grid based on the detection information from the plurality of heterogeneous sensors;
means for determining occupancy probabilities for a plurality of cells in the single measurement grid; and
means for outputting the occupancy grid based at least in part on the occupancy probabilities.

Clause 20. The apparatus of clause 19 wherein the means for generating the single measurement grid includes means for combining the detection information in a single data buffer.

Clause 21. The apparatus of either clause 19 or clause 20 wherein the plurality of heterogeneous sensors includes a first radar configured to detect targets in a first area, and a second radar configured to detect targets in a second area that is different from the first area.

Clause 22. The apparatus of any of clauses 19-21 wherein the plurality of heterogeneous sensors includes at least one of a lidar and a camera.

Clause 23. The apparatus of any of clauses 19-22 wherein the means for obtaining the detection information includes means for receiving remote sensor detection information via a network interface.

Clause 24. The apparatus of any of clauses 19-23 wherein the occupancy probabilities include an occupied probability and a free probability for each of the plurality of cells.

Clause 25. The apparatus of any of clauses 19-24 wherein the occupancy probabilities include a dynamic probability and a static probability for each of the plurality of cells.

Clause 26. The apparatus of any of clauses 19-25 wherein the occupancy grid includes a grid cell state with a velocity indication for at least one of the plurality of cells.

Clause 27. A non-transitory processor-readable storage medium comprising processor-readable instructions configured to cause one or more processors to generate an occupancy grid, comprising code for:
obtaining detection information from a plurality of heterogeneous sensors;
generating a single measurement grid based on the detection information from the plurality of heterogeneous sensors;
determining occupancy probabilities for a plurality of cells in the single measurement grid; and
outputting the occupancy grid based at least in part on the occupancy probabilities.

Clause 28. The non-transitory processor-readable storage medium of clause 27 wherein the code for generating the single measurement grid includes code for combining the detection information in a single data buffer.

Clause 29. The non-transitory processor-readable storage medium of either clause 27 or clause 28 wherein the plurality of heterogeneous sensors includes a first radar configured to detect targets in a first area, and a second radar configured to detect targets in a second area that is different from the first area.

Clause 30. The non-transitory processor-readable storage medium of any of clauses 27-29 wherein the plurality of heterogeneous sensors includes at least one of a lidar and a camera.

Clause 31. The non-transitory processor-readable storage medium of any of clauses 27-30 wherein the code for obtaining the detection information includes code for receiving remote sensor detection information via a network interface.

Clause 32. The non-transitory processor-readable storage medium of any of clauses 27-31 wherein the occupancy probabilities include an occupied probability and a free probability for each of the plurality of cells.

Clause 33. The non-transitory processor-readable storage medium of any of clauses 27-32 wherein the occupancy probabilities include a dynamic probability and a static probability for each of the plurality of cells.

Clause 34. The non-transitory processor-readable storage medium of any of clauses 27-33 wherein the occupancy grid includes a grid cell state with a velocity indication for at least one of the plurality of cells.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors. Also, a “set” as used herein includes one or more members, and a “subset” contains fewer than all members of the set to which the subset refers.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, a list of items prefaced by “at least one of” or prefaced by “one or more of” indicates a disjunctive list such that, for example, a list of “at least one of A, B, or C,” or a list of “at least one of A, B, and C,” or a list of “one or more of A, B, or C”, or a list of “one or more of A, B, and C,” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of +20% or +10%, +5%, or +0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A method for generating an occupancy grid, comprising:
obtaining detection information from a plurality of heterogeneous sensors;
generating a single measurement grid based on the detection information from the plurality of heterogeneous sensors;
determining occupancy probabilities for a plurality of cells in the single measurement grid; and
outputting the occupancy grid based at least in part on the occupancy probabilities.

2. The method of claim 1 wherein generating the single measurement grid includes combining the detection information in a single data buffer.

3. The method of claim 1 wherein the plurality of heterogeneous sensors includes a first radar configured to detect targets in a first area, and a second radar configured to detect targets in a second area that is different from the first area.

4. The method of claim 1 wherein the plurality of heterogeneous sensors includes a lidar.

5. The method of claim 1 wherein the plurality of heterogeneous sensors includes a camera.

6. The method of claim 1 wherein obtaining the detection information includes receiving remote sensor detection information via a network interface.

7. The method of claim 1 wherein the occupancy probabilities include an occupied probability and a free probability for each of the plurality of cells.

8. The method of claim 1 wherein the occupancy probabilities include a dynamic probability and a static probability for each of the plurality of cells.

9. The method of claim 1 wherein the occupancy grid includes a grid cell state with a velocity indication for at least one of the plurality of cells.

10. An apparatus, comprising:
at least one memory;
a plurality of heterogeneous sensors;
at least one processor communicatively coupled to the at least one memory and the plurality of heterogeneous sensors, configured to:
obtain detection information from the plurality of heterogeneous sensors;
generate a single measurement grid based on the detection information from the plurality of heterogeneous sensors;
compute occupancy probabilities for a plurality of cells in the single measurement grid; and
output an occupancy grid based at least in part on the occupancy probabilities.

11. The apparatus of claim 10 wherein the at least one processor is further configured to combine the detection information in a single data buffer in the at least one memory.

12. The apparatus of claim 10 wherein the plurality of heterogeneous sensors includes a first radar configured to detect targets in a first area, and a second radar configured to detect targets in a second area that is different from the first area.

13. The apparatus of claim 10 wherein the plurality of heterogeneous sensors includes a lidar.

14. The apparatus of claim 10 wherein the plurality of heterogeneous sensors includes a camera.

15. The apparatus of claim 10 wherein the at least one processor is further configured to receive remote sensor detection information via a network interface.

16. The apparatus of claim 10 wherein the occupancy probabilities include an occupied probability and a free probability for each of the plurality of cells.

17. The apparatus of claim 10 wherein the occupancy probabilities include a dynamic probability and a static probability for each of the plurality of cells.

18. The apparatus of claim 10 wherein the occupancy grid includes a grid cell state with a velocity indication for at least one of the plurality of cells.

19. An apparatus for generating an occupancy grid, comprising:
means for obtaining detection information from a plurality of heterogeneous sensors;
means for generating a single measurement grid based on the detection information from the plurality of heterogeneous sensors;
means for determining occupancy probabilities for a plurality of cells in the single measurement grid; and
means for outputting the occupancy grid based at least in part on the occupancy probabilities.

20. The apparatus of claim 19 wherein the means for generating the single measurement grid includes means for combining the detection information in a single data buffer.
